(19) United States
(12) Patent Application Publication
(10) Pub. No.: US 2021/0107178 A1
(43) Pub. Date: Apr. 15, 2021

(54) EXTRUSION MOLDING MACHINE, AND METHOD FOR PRODUCING MOLDED BODY

(71) Applicant: NGK INSULATORS, LTD., Nagoya-Shi (JP)

(72) Inventors: Keita ITO, Nagoya-Shi (JP); Yuichi TAJIMA, Nagoya-Shi (JP); Yoshimasa KONDO, Nagoya-Shi (JP)

(73) Assignee: NGK INSULATORS, LTD., Nagoya-Shi (JP)

(21) Appl. No.: 17/132,323

(22) Filed: Dec. 23, 2020

Related U.S. Application Data
(63) Continuation of application No. PCT/JP2019/015687, filed on Apr. 10, 2019.

(51) Int. Cl. B28B 3/20; B28B 3/22

(52) U.S. Cl. CPC B28B 3/201; B28B 2003/203; B28B 3/22

(57) ABSTRACT

An extrusion molding machine 1, including: an extruding portion 10 having a screw 11 and a barrel 12 capable of housing the screw; a molding portion 20 having one end and other end, the one end having a die 21, and the other end being connected to an extruding port 13 of the extruding portion 10; and a rectifier 30 arranged between the extruding portion 10 and the molding portion 20. A heat insulating member 40 is further arranged between the molding portion 20 and the rectifier 30.

### FIELD OF THE INVENTION

The present invention relates to an extrusion molding machine and a method for producing a molded body.

### BACKGROUND OF THE INVENTION

Extrusion molding machines are used to produce various molded bodies. For example, the mainstream of the production of honeycomb-shaped ceramic structures used for catalyst supports for purifying exhaust gases from motor vehicles, diesel particulate filters (DPFs), gasoline particulate filters (GPFs), heat storage bodies for combustion devices, and the like has been the production of honeycomb-shaped ceramic formed bodies using extrusion molding machines, in terms of productivity.

By the way, the ceramic structure used for applications such as DPFs and GPFs tends to cause defects such as cracking due to thermal stress or the like, if it has lower dimensional accuracy. Therefore, higher dimensional accuracy is also required for a ceramic molded body before firing.

As a technique for improving the dimensional accuracy of the molded body obtained by the extrusion molding machine, for example, Patent literature 1 proposes that the dimensional accuracy is improved by controlling an extrusion rate of an extruded product by arranging a heating element in a front section adjacent to an extrusion molding die and controlling a temperature of a ceramic batch material (a molding material).

Further, Patent Literature 2 proposes that the dimensional accuracy of the molded body is improved by achieving a uniform extrusion rate of a raw material composition (a molding material) introduced into a die of an extrusion molding machine by arranging a plurality pins provided in a resistance tube between a rectifier and the die so as to penetrate a tube wall of the resistance tube, each pin having a changeable length protruding to an interior of the resistance tube, and controlling a temperature of each pin.

### CITATION LIST

### Patent Literatures

### [Patent Literature 1] Japanese Patent No. 6258962 B

### [Patent Literature 2] Japanese Patent Application Publication No. 2013-193278 A

### SUMMARY OF THE INVENTION

The present invention relates to an extrusion molding machine, comprising: an extruding portion having a screw and a barrel capable of housing the screw; a molding portion having one end and other end, the one end having a die, and the other end being connected to an extruding port of the extruding portion; and a rectifier arranged between the extruding portion and the molding portion, wherein a heat insulating member is arranged between the molding portion and the rectifier.

### BRIEF DESCRIPTION OF THE DRAWINGS

FIG. 1 is a schematic view illustrating a schematic structure of an extrusion molding machine according to Embodiment 1 of the present invention;

FIG. 2 is a front view of a heat insulating member as viewed from a rectifier side;

FIG. 3 is a schematic view illustrating a schematic structure of an extrusion molding machine according to Embodiment 2 of the present invention;

FIG. 4 is a front view of a temperature control drum as viewed from a drum side;

FIG. 5 is a schematic view illustrating a schematic structure of an extrusion molding machine according to Embodiment 3 of the present invention;

FIG. 6 is measurement results of temperature distributions of molded bodies in Examples; and

FIG. 7 is a schematic view for explaining a method of measuring a protruding amount from a photograph.

### DETAILED DESCRIPTION OF THE INVENTION

The technique described in Patent Literature 1 requires many devices for controlling the temperature of the molding material, leading to an increase in size and complication of the machine. Further, it increases an amount of electricity when heating the molding material, resulting in increased production costs.

The technique described in Patent literature 2 blocks the flow of the molding material by the pins, and thus has to increase an extrusion pressure in order to ensure the specific extrusion rate. Further, it has a small contact area between each pin and the molding material, so that it requires a long period of time to control the temperature by the pins.

Thus, the conventional techniques for improving the dimensional accuracy of the molded body have various problems as described above. Therefore, there is a need for developing other techniques to produce a molded body having higher dimensional accuracy.

The present invention has been made to solve the above problems. An object of the present invention is to provide an extrusion molding machine capable of producing a molded body having higher dimensional accuracy.

Another object of the present invention is to provide a method for producing a molded body having higher dimensional accuracy.

As a result of intensive studies to solve the above problems, the present inventors have found that a non-uniform temperature distribution of the molding material, which affects the extrusion rate, is caused by cooling of a molding portion with an extruding portion, and based on the finding, a heat insulating member is arranged at a predetermined position, thereby enabling a uniform temperature distribution of the molding material, and have completed the present invention.

According to the present invention, it is possible to provide an extrusion molding machine capable of producing a molded body having higher dimensional accuracy.

Further, according to the present invention, it is possible to provide a method for producing a molded body having higher dimensional accuracy.

Hereinafter, embodiments of the present invention will be specifically described. It is to understand that the present invention is not limited to the following embodiments, and those which appropriately added changes, improvements and the like to the following embodiments based on knowledge of a person skilled in the art without departing from the spirit of the present invention fall within the scope of the present invention.

### Embodiment 1

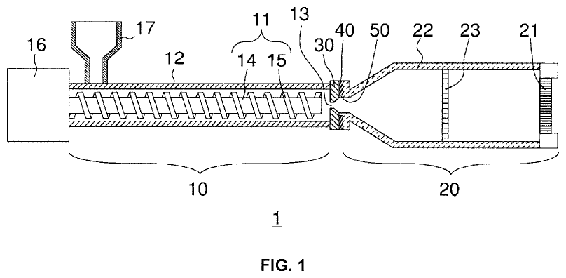

FIG. 1 is a schematic view illustrating a schematic structure of an extrusion molding machine according to Embodiment 1 of the present invention.

As shown in FIG. 1, an extrusion molding machine 1 according to the present embodiment includes: an extruding portion 10; a molding portion 20 connected to the extruding portion 10; a rectifier 30 arranged between the extruding portion 10 and the molding portion 20; and a heat insulating member 40 arranged between the molding portion 20 and the rectifier 30. The extruding portion 10 has a screw 11 and a barrel 12 capable of housing the screw 11. Further, the molding portion 20 includes one end and other end, and the one end has a die 21, and the other end is connected to an extruding port 13 of the extruding portion 10.

In the extrusion molding machine 1 having the above structure, a molding material is kneaded in the extruding portion 10. At this time, a higher temperature of an interior of the extruding portion 10 may result in drying and hardening of the molding material. Therefore, the extruding portion 10 is cooled in order to control the temperature of the interior of the extruding portion 10.

On the other hand, the molding portion 20 is not cooled. Therefore, the temperature of the molding material discharged from the extruding port 13 of the extruding portion 10 gradually rises as the molding material progresses to the molding portion 20 through the rectifier 30.

In the conventional extrusion molding machine, the heat insulating member 40 is not arranged between the molding portion 20 and the rectifier 30, so that the molding portion 20 on the extruding portion 10 side is also cooled by an influence of the cooled extruding portion 10. In such a state, a temperature of a central portion of the molding material in a cross section perpendicular to an extrusion direction (advancing direction) tends to increase, and a temperature of an outer peripheral portion tends to decrease. The temperature of the molding material affects an extrusion rate. Therefore, the extrusion rate of the central portion is higher and the extrusion rate of the outer peripheral portion is lower, so that a molded body having desired dimensional accuracy cannot be obtained.

In contrast, the extrusion molding machine 1 according to the present embodiment arranges the heat insulating member 40 between the molding portion 20 and the rectifier 30, so that the heat of the space between the extruding portion 10 and the molding portion 20 is insulated, and the effect of the cooled molding portion 10 can prevent the molding portion 20 on the extruding portion 10 side from being cooled. Therefore, in the cross section perpendicular to the extrusion direction of the molding material, a difference between the temperature of the central portion and the temperature of the outer peripheral portion is decreased. This can a uniform extrusion rate in the molding portion 20 to be achieved, thereby improving dimensional accuracy of the molded body.

Hereinafter, the members forming the extrusion molding machine 1 according to the present embodiment will be described in detail.

### (Extruding Portion 10)

The extruding portion 10 is not particularly limited as long as it has the screw 11 and the barrel 12 capable of housing the screw 11. Any member known in the art can be used.

The screw 11 preferably has a screw shaft 14 and a blade portion 15 that is spirally formed along the screw shaft 14.

Further, the screw 11 is preferably a biaxial screw that rotates in the same direction, from the viewpoint of kneading properties of the ceramic molding material, and more preferably a meshing type biaxial screw. In this case, a pair of screws 11 are arranged in parallel inside the barrel 12.

A base portion of the screw 11 is connected to a drive device 16. The drive device 16 includes a motor and a gearbox (not shown), and controls a rotation speed so as to obtain a predetermined extrusion pressure and rotates the screw 11.

Provided on an upstream side of the extruding portion 10 is a material introducing portion 17 for feeding the molding material into the extruding portion 10. The molding material fed from the material introducing portion 17 is kneaded by the screw 11 and fed to the molding portion 20.

### (Molding Portion 20)

The molding portion 20 includes a drum 22 having a space therein. One end of the molding portion 20 has a die 21, and the other end is connected to the extruding portion 13 of the extruding portion 10.

A shape of the drum 22 is not particularly limited, and a part of the dram 22 may have a decreased diameter portion or an increased diameter portion. For example, as shown in FIG. 1, the drum 22 has the increased diameter portion on the extruding port 13 side. The drum 22 having such a structure may be composed of one member or may be composed of a plurality of members. When the drum 22 is composed of a plurality of members, the drum 22 can be obtained by combining an increased diameter drum and a straight drum.

A shape of the die 21 is not particularly limited, and it can be appropriately set according to the shape of the molded body to be produced. For example, when producing a molded body having a honeycomb shape, the die 21 having slits corresponding to the thickness of the partition walls of the honeycomb molded body is used.

It is preferable that a screen (filtration net) 23 is provided in the drum 22 (molding portion 20). The screen 23 is formed of a material in the form of mesh, and can remove coarse particles or other impurities mixed in the molding material to stabilize the molding material fed to the die 21.

An outer circumference of the drum 22 (molding portion 20) is preferably covered with a heat insulating sheet (not shown). This structure can allow the interior of the drum 22 to be maintained at a constant temperature, so that, in the cross section perpendicular to the extrusion direction of the molding material, the difference between the temperature of the central portion and the temperature of the outer peripheral portion is decreased and the effect of improving the dimensional accuracy of the molded body can be enhanced.

### (Rectifier 30)

The rectifier 30 is arranged between the extruding portion 10 and the molding portion 20. The rectifier 30 has through holes, which have a function of adjusting the behavior of the molding material.

A number, position and shape of the through holes are not particularly limited, and they can be set as needed.

Examples of a material of the rectifier 30 that can be used include, but not particularly limited to, iron-based or stainless steel-based materials.

### (Heat Insulating Member 40)

The heat insulating member 40 is arranged between the molding portion 20 and the rectifier 30.

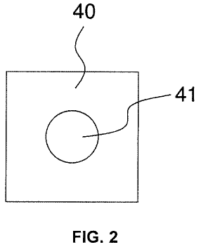

Here, FIG. 2 shows a front view of the heat insulating member 40 as viewed from the rectifier 30 side. As shown in FIG. 2, the heat insulating member 40 has a through hole 41 through which the molding material can pass, at the central portion.

The heat insulating member 40 is not particularly limited, but it preferably has a thermal conductivity of 0.5 W/m·K or less. With the heat insulating member 40 having such thermal conductivity, the heat insulating effect between the extruding portion 10 and the molding portion 20 can be sufficiently ensured. A lower thermal conductivity of the heat insulating member 40 is preferable, because the lower thermal conductivity produces a higher the heat insulating effect. However, the lower limit of the thermal conductivity may be 0.02 W/m·K in view of available materials. Further, as used herein, the “thermal conductivity” means the thermal conductivity measured at 25° C.

The heat insulating member 40 in the extrusion direction has a non-limiting length, but the thickness is preferably from 1 to 50 mm. The heat insulating member 40 having such a thickness can allow the heat insulating effect between the extruding portion 10 and the molding portion 20 to be sufficiently ensured.

A material of the heat insulating member 40 is not particularly limited as long as it has heat insulating properties, but it is preferably formed of a heat insulating resin.

The heat insulating resin is not particularly limited. Resins known in the art can be used. Examples of the heat insulating resin include synthetic resins such as a polyacetal resin, a polyamide resin, a polyethylene resin, and a polypropylene resin.

The heat insulating member 40 may be in contact with the molding material, but it may be worn due to the contact with the molding material. In such a case, it is preferable to arrange a protective member 50 for protecting the heat insulating member 40 at a position that will be in contact with the molding material, between the molding portion 20 and the rectifier 30.

The protective member 50 may be an individual component. However, as shown in FIG. 1, the protective member 50 may be integrally formed with the drum 22 by processing an end portion of the drum 22 that will be in contact with the heat insulating member 40.

A material of the protective member 50 is not particularly limited. The same material as that of the drum 22 (for example, iron-based materials, stainless steel-based materials, and the like) can be used.

The extrusion molding machine 1 having the above structure can be used in a method for producing a molded body. In particular, the extrusion molding machine 1 is suitable for use in a method for producing a ceramic molded body using a ceramic molding material, especially a honeycomb ceramic molded body.

According to the method for producing the molded product using this extrusion molding machine 1, it is possible to provide a molded body having higher dimensional accuracy.

In the method for producing the molded body, first, the molding material is fed from the material introducing portion 17 to the interior of the barrel 12. The molding material is kneaded while being subjected to shearing force by the rotation of the screw 11, and is conveyed to the extruding port 13 side at the tip of the barrel 12. The molding material extruded from the extruding port 13 of the barrel 12 passes through the through holes of the rectifier 30, and passes through the screen 23 to be fed to the die 21. The molding material is extruded through the die 21 to provide a molded body having a desired shape.

### Embodiment 2

An extrusion molding machine according to Embodiment 2 of the present invention is the same as the extrusion molding machine according to Embodiment 1, with the exception that the former provides a temperature controller. Therefore, descriptions of the configurations common to the extrusion molding machine according to Embodiment 1 of the present invention will be omitted herein, and only different configurations will be described.

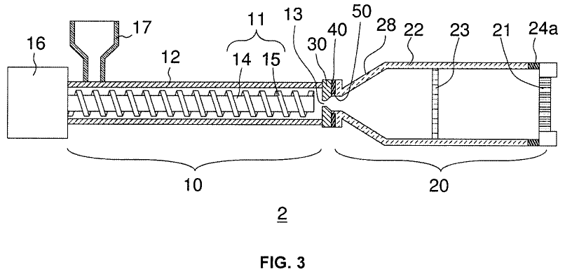

FIG. 3 is a schematic view illustrating a schematic structure of an extrusion molding machine according to Embodiment 2 of the present invention.

As shown in FIG. 3, an extrusion molding machine 2 according to the present embodiment is provided with a temperature controller 24a between the screen 23 and the die 21. By controlling the temperature of the outer peripheral portion of the molding material by the temperature controller 24a, it will be difficult for a protruding portion to be formed on the end face of the molded body, and the dimensional accuracy of the molded body can be further improved. For example, the above effect can be obtained by heating the outer peripheral portion of the molding material by the temperature controller 24a so as to increase the temperature of the outer peripheral portion as compared with the central portion, although it depends on the size of the molded product to be produced (particularly, the diameter in the cross section perpendicular to the extrusion direction) and/or the characteristics of the molding material to be used. However, since the above effect may be obtained when the difference between the temperature of the outer peripheral portion and the temperature of the central portion is smaller, the temperature control should be performed by the temperature controller 24a depending on the size of the molded body to be produced and/or the characteristics of the molding material to be used.

The temperature controller 24a is not particularly limited. Any temperature controller known in the art can be used. Among others, it is preferable to use a temperature control drum through which a fluid can flow, as the temperature controller 24a. Since the temperature control drum can control the temperature by adjusting the temperature of the fluid, it is possible to reduce the consumption of electricity as compared with a case where a heating means such as a heating element is used. For example, the molding material can be easily and efficiently heated by circulating hot water having a temperature controlled by using a boiler or the like through the temperature control drum.

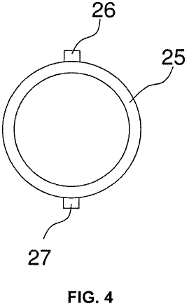

Here, FIG. 4 shows a front view of the temperature control drum as viewed from the drum 22 side. As shown in FIG. 4, the temperature control drum 25 has a fluid feed port 26 and a fluid discharge port 27, and forms a fluid flow path in the circumferential direction. Although not shown, the feed port 26 and the discharge port 27 are connected to a fluid feed device via a tube or the like. By circulating the fluid while controlling the temperature of the fluid by this feed device, the temperature can be easily controlled.

### Embodiment 3

An extrusion molding machine according to Embodiment 3 of the present invention is the same as the extrusion molding machine 2 according to Embodiment 2, with the exception that the former further provides a temperature controller at an increased diameter portion of the molding portion 20. Therefore, descriptions of the configurations common to the extrusion molding machine 2 according to Embodiment 2 of the present invention will be omitted herein, and only different configurations will be described.

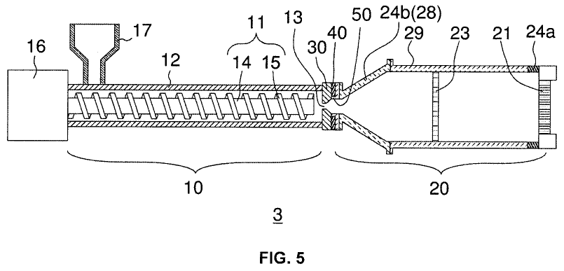

FIG. 5 is a schematic view illustrating a schematic structure of an extrusion molding machine according to Embodiment 3 of the present invention.

As shown in FIG. 5, an extrusion molding machine 3 according to the present embodiment has an increased diameter portion on the extruding portion 12 side of the molding portion 20, and the increased diameter portion is provided with a temperature controller 24b. By controlling the temperature of the outer peripheral portion of the molding material by the temperature controller 24b, it will be difficult for a protruding portion to be formed on the end face of the molded body, and the dimensional accuracy of the molded body can be further improved. For example, the above effect can be obtained by heating the outer peripheral portion of the molding material by the temperature controller 24b so as to increase the temperature of the outer peripheral portion as compared with the central portion, although it depends on the size of the molded product to be produced (particularly, the diameter in the cross section perpendicular to the extrusion direction) and/or the characteristics of the molding material to be used. However, since the above effect may be obtained when the difference between the temperature of the outer peripheral portion and the temperature of the central portion is smaller, the temperature control should be performed by the temperature controller 24b depending on the size of the molded body to be produced and/or the characteristics of the molding material to be used.

The temperature controller 24b is not particularly limited. Any temperature controller known in the art can be used. For example, as shown in FIG. 5, the molding portion 20 may be formed by using an increased diameter drum 28 and a straight drum 29, and a temperature control drum through which a fluid can flow may be used as the increased diameter drum 28. The temperature control drum used for the increased diameter drum 28 can have the same configuration as that of the temperature control drum 25 used in Embodiment 2 of the present invention, with the exception that the diameter is increased along the axial direction of the temperature control drum.

While the above text describes only the features of the extrusion molding machine 3 according to Embodiment 3 of the present invention, which are different from those of the extrusion molding machine 2 according to Embodiment 2 of the present invention, it should be noted that the features can also be applied to extrusion molding machine 1 according to Embodiment 1.

### EXAMPLES

Hereinafter, the present invention will be more specifically described with reference to Examples, but the present invention is not limited to these Examples.

### Example 1

The extrusion molding machine 1 having the heat insulating member 40 as illustrated in FIG. 1 was manufactured. The heat insulating member 40 was formed of a polyacetal resin having a thermal conductivity of 0.25 W/m·K, and had a thickness of 10 mm in the extrusion direction. Further, both of the drum 22 and the rectifier 30 were formed of an iron-based material, and the protective member 50 for protecting the heat insulating member 40 was integrally formed with the drum 22. A contact area between the drum 22 (protective member 50) and the rectifier 30 was 6 cm².

### Example 2

The extrusion molding machine 2 having the heat insulating member 40 and the temperature controller 24a as shown in FIG. 3 was manufactured. The temperature control drum 25 was used as the temperature controller 24a, and hot water at 45° C. was circulated through the temperature control drum 25. Further, the configurations other than the temperature controller 24a were the same as those of Example 1.

### Example 3

The extrusion molding machine 2 having the heat insulating member 40 and the temperature controllers 24a, 24b as shown in FIG. 5 was manufactured. The temperature control drum was used as the temperature controller 24a, and the temperature control drum having the increased diameter portion was used as the temperature controller 24b, and hot water at 45° C. was circulated through each of the temperature control drums. Further, the configurations other than the temperature controllers 24a, 24b were the same as those of Example 1.

### Comparative Example 1

A conventional extrusion molding machine that did not have the heat insulating member 40 and the temperature controllers 24a, 24b was prepared. The configuration of each member of this extrusion molding machine was the same as that of Examples 1 to 3. A contact area between the drum 22 and the rectifier 30 was 150 cm².

Using the extrusion molding machines 1 to 3 of Examples as described above and the extrusion molding machine of Comparative Example, each cordierite-based ceramic molding material was molded with a feeding amount of the molding material of 300 kg/h at a rotation speed of the screw 11 of 55 rpm to form a circular pillar shaped ceramic honeycomb molded body (having a diameter of 196 mm in the cross section perpendicular to the extrusion direction). The resulting circular pillar shaped ceramic honeycomb molded bodies were evaluated as follows.

### (Temperature Distribution of Molded Body)

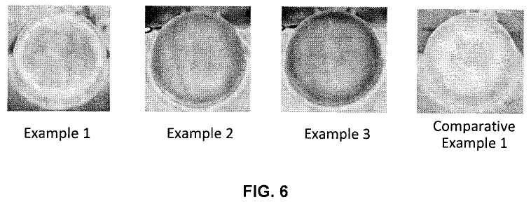

The temperature distribution of each ceramic honeycomb molded body immediately after being discharged from the die 21 was measured using an infrared thermography camera (Thermo GEAR G120EX from Nippon Avionics Co., Ltd.). With regard to the result of the temperature distribution, FIG. 6 shows the result of the entire cross section perpendicular to the extrusion direction of each ceramic honeycomb molded body. Also, Table 1 shows the temperatures of the outer peripheral portion and the central portion of each ceramic honeycomb molded body in the cross section perpendicular to the extrusion direction.

### (Roundness)

The roundness of each ceramic honeycomb molded body was measured using a digital caliper. The results are shown in Table 1.

### (Protruding Amount of End Face of Molded Body)

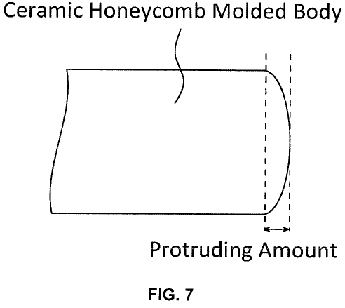

After cutting each ceramic honeycomb molded body immediately after being discharged from the die 21 in the direction perpendicular to the extrusion direction, the cut surface was photographed from a direction perpendicular to the extrusion direction, and the protruding amount of the end face of each molded body was measured. The protruding amount was measured by drawing a straight line connecting two outer peripheral end face portions in the photograph and determining a distance of the convex portion protruding with respect to the straight line. FIG. 7 shows a schematic view for explaining a method of measuring the protruding amount from the photograph. The results are shown in Table 1.

TABLE 1

| | | Example | Example | Example | Comparative |
|---|---|---|---|---|---|
| | | 1 | 2 | 3 | Example 1 |
| Temperature | Outer | 30 | 34 | 35 | 29 |
| Distribution | Peripheral | | | | |
| (° C.) | Portion | | | | |
| | Central | 31 | 31 | 31 | 31 |
| | Portion | | | | |

| | | | | |
|---|---|---|---|---|
| Roundness (mm) | 1.36 | 1.10 | 0.96 | 1.50 |
| Protruding Amount | 5.0 | 2.0 | 1.0 | 10.0 |
| (mm) | | | | |

As shown in Table 1 and FIG. 6, the extrusion molding machine 1 having the heat insulating member 40 according to Example 1 had a uniform temperature distribution of the molded body and provided a molded body having good roundness and an decreased protruding amount as compared with the extrusion molding machine that did not have the heat insulating member 40 according to Comparative Example 1.

Further, the extrusion molding machine 2 having the additional temperature controller 24a according to Example 2 provided a molded product having better results of the roundness and the protruding amount than those of the extrusion molding machine 1 according to Example 1.

Furthermore, the extrusion molding machine 2 having the further temperature controller 24b according to Example 3 provided a molded product having better results of the roundness and the protruding amount than those of the extrusion molding machine 2 according to Example 2.

As can be seen from the above results, the present invention can provide an extrusion molding machine capable of producing a molded body having higher dimensional accuracy. Further, the present invention can provide a method for producing a molded body having higher dimensional accuracy.

### DESCRIPTION OF REFERENCE NUMERALS

1, 2, 3 extrusion molding machine
10 extruding portion
11 screw
12 barrel
13 extruding port
14 screw shaft
15 blade portion
16 drive device
17 material introducing portion
20 molding portion
21 die
22 drum
23 screen
24a, 24b temperature controller
25 temperature control drum
26 feed port
27 discharge port
28 increased diameter drum
29 straight drum
30 rectifier
40 heat insulation member
41 through hole
50 protective member

1. An extrusion molding machine, comprising:
an extruding portion having a screw and a barrel capable of housing the screw;
a molding portion having one end and other end, the one end having a die, and the other end being connected to an extruding port of the extruding portion; and
a rectifier arranged between the extruding portion and the molding portion,
wherein a heat insulating member is arranged between the molding portion and the rectifier.

2. The extrusion molding machine according to claim 1, wherein the heat insulating member has a thermal conductivity of 0.5 W/m·K or less.

3. The extrusion molding machine according to claim 1, wherein the heat insulating member has a thickness of from 1 to 50 mm in an extrusion direction.

4. The extrusion molding machine according to claim 1, wherein the heat insulating member is formed of a heat insulating resin.

5. The extrusion molding machine according to claim 4, wherein a protective member for protecting the heat insulating member is arranged at a position that will be in contact with the molding material, between the molding portion and the rectifier.

6. The extrusion molding machine according to claim 1, wherein a temperature controller is provided in the molding portion.

7. The extrusion molding machine according to claim 6, wherein a screen is provided in the molding portion, and the temperature controller is provided between the screen and the die.

8. The extrusion molding machine according to claim 6, wherein the molding portion has an increased diameter portion, and the temperature controller is provided in the increased diameter portion.

9. The extrusion molding machine according to claim 6, wherein the temperature controller is a temperature control drum through which a fluid can flow.

10. The extrusion molding machine according to claim 1, wherein the outer circumference of the molding portion is covered with a heat insulating sheet.

11. The extrusion molding machine according to claim 1, wherein the extrusion molding machine is used for producing a ceramic molded product.

12. A method for producing a molded product, comprising molding a molding material using the extrusion molding machine according to claim 1.
